(19) United States
(12) Patent Application Publication
(10) Pub. No.: US 2017/0195079 A1
(43) Pub. Date: Jul. 6, 2017

(54) OPTICAL TRANSCEIVER ASSEMBLY INCLUDING THERMAL DUAL ARRAYED WAVEGUIDE GRATING

(71) Applicant: Applied Optoelectronics, Inc., Sugar Land, TX (US)

(72) Inventors: Jun ZHENG, Missouri City, TX (US); I-Lung HO, Sugar Land, TX (US); Chong WANG, Stafford, TX (US)

(21) Appl. No.: 14/983,773

(22) Filed: Dec. 30, 2015

(51) Int. Cl. H04J 14/02; H04Q 11/00; H04B 10/40

(52) U.S. Cl. CPC H04J 14/0221; H04B 10/40; H04Q 11/0066; H04Q 2011/0032; H04Q 2011/0016; H04Q 2011/0035

(57) ABSTRACT

An optical transceiver assembly includes a thermal dual arrayed waveguide grating (AWG) for both multiplexing and demultiplexing optical signals. The thermal dual AWG may be used as an optical multiplexer/demultiplexer with an array of laser emitters and an array of photodetectors to provide a transmitter optical subassembly (TOSA) and a receiver optical subassembly (ROSA) in the optical transceiver assembly. The thermal dual AWG may be formed as a single chip, and a temperature control device, such as thermoelectric cooler (TEC), may be used in the transceiver to stabilize the temperature of the AWG. In an embodiment, an external reflector may be used at a transmit output of the dual AWG to complete the lasing cavities after the AWG, thereby providing a laser array mux assembly. The optical transceiver device may also be part of a larger system, such as a wavelength division multiplexed (WDM) passive optical network (PON).

### TECHNICAL FIELD

The present application relates to optical communications, and more particularly, to a thermal dual arrayed waveguide grating for providing both transmit and receive functionality in a device.

### BACKGROUND

Optical communications networks may employ optical transceiver devices to prepare optical signals for transmission or for converting optical signals back into the electrical domain. Optical transceiver devices typically include a transmit optical sub-assembly (TOSA) to transmit optical signals or a receive optical sub-assembly (ROSA) to receive optical signals. It may be desirable to include both a TOSA and ROSA within the same device, but there are challenges to this integration. For example, a device that comprises both a TOSA and ROSA may require measures to account for heat generated by the various components performing this functionality. The TOSA and ROSA may each comprise at least one arrayed waveguide grating (AWG) to perform demultiplexing/multiplexing functionality. The performance of a “thermal” AWG may vary depending on temperature, while an “athermal” AWG may provide consistent performance regardless of temperature. While it may be preferable to design an optical transceiver with both a TOSA and ROSA using athermal AWGs in view of their consistent performance regardless of temperature, the cost of an athermal AWG is substantially higher than a thermal AWG. Thermal AWGs have lower cost, but require heat management to maintain performance. Thermoelectric coolers (TECs) have traditionally been deployed to control heat on a per-AWG basis, but the use of more than one TEC in a single device may be problematic from a power consumption standpoint.

### BRIEF DESCRIPTION OF THE DRAWINGS

Reference should be made to the following detailed description which should be read in conjunction with the following figures, wherein like numerals represent like parts:

FIG. 1 illustrates an example configuration for an optical transceiver including a thermal dual arrayed waveguide grating (AWG) consistent with the present disclosure;

FIG. 2 illustrates a functional diagram of an example wavelength division multiplexed (WDM) passive optical network (PON) including optical transceivers with thermal dual AWGs consistent with the present disclosure;

FIG. 3 illustrates an example implementation of a thermal dual AWG used in an optical transceiver consistent with the present disclosure; and

FIG. 4 illustrates an example implementation of a thermal dual AWG with extended lasing cavities used in an optical transceiver consistent with the present disclosure.

Although the following Detailed Description will proceed with reference being made to illustrative embodiments, many alternatives, modifications and variations thereof will be apparent to those skilled in the art.

### DETAILED DESCRIPTION

An optical transceiver assembly, consistent with embodiments of the present disclosure, includes at least one thermal dual arrayed waveguide grating (AWG) for both multiplexing and demultiplexing optical signals. The thermal dual AWG may be used as an optical multiplexer/demultiplexer with an array of laser emitters and an array of photodetectors to provide both a transmitter optical subassembly (TOSA) and a receiver optical subassembly (ROSA) in the optical transceiver assembly. The thermal dual AWG may be formed as a single chip, and a temperature control device, such as thermoelectric cooler (TEC), may be used in the transceiver to stabilize the temperature of the AWG. In an embodiment, an external reflector may be used at a transmit output of the dual AWG to complete the lasing cavities after the AWG, thereby providing a laser array mux assembly. The optical transceiver device may also be part of a larger system, such as a wavelength division multiplexed (WDM) passive optical network (PON).

In at least one embodiment, an optical transceiver device may comprise, for example, a thermal dual AWG, a plurality of laser emitters, a plurality of photodetectors and a TEC. The thermal dual AWG may include at least one set of transmit inputs, at least one transmit output and at least one set of transmit waveguides between the transmit inputs and the transmit output to multiplex optical signals into a multiplexed optical signal for transmission, thereby forming a transmit portion of the dual AWG. In addition, the thermal dual AWG may include at least one receive input, at least one set of receive outputs and at least one set of receive waveguides between the receive input and the receive outputs to demultiplex a received multiplexed optical signal, thereby forming a receive portion of the dual AWG. In at least one example configuration, the plurality of laser emitters may be optically coupled to the transmit inputs, and the plurality of photodetectors may be optically coupled to the receive outputs. The TEC may be thermally coupled to at least the thermal dual AWG and may be configured to control a temperature of at least the thermal dual AWG. As used herein, “thermal AWG” refers to a temperature-sensitive AWG in which the wavelength shift over a temperature range of about 0° C. to 85° C. is greater than about 0.05 nm.

For example, the transmit portion and the receive portion of the dual AWG at least partially overlap each other to facilitate the thermal coupling to the TEC. The partially overlapping arrangement may facilitate substantially all of a combined surface area of the transmit portion and the receive portion being thermally coupled to a temperature control surface of the TEC. The plurality of laser emitters may each be coupled to the transmit inputs, respectively, and the plurality of photodetectors may each be coupled to the receive outputs, respectively. The optical transceiver device may further comprise a housing to house the thermal dual AWG, the plurality of laser emitters, the plurality of photodetectors and the TEC. The TEC may also be thermally coupled to the plurality of laser emitters and the TEC may be configured to control a temperature of the plurality of laser emitters.

In at least one embodiment, the optical transceiver device may further comprise an external reflector coupled to the transmit output to form external laser cavities in the at least one set of transmit waveguides. The plurality of laser emitters may be gain chips such as, for example, Fabry-Perot (FP) laser emitters.

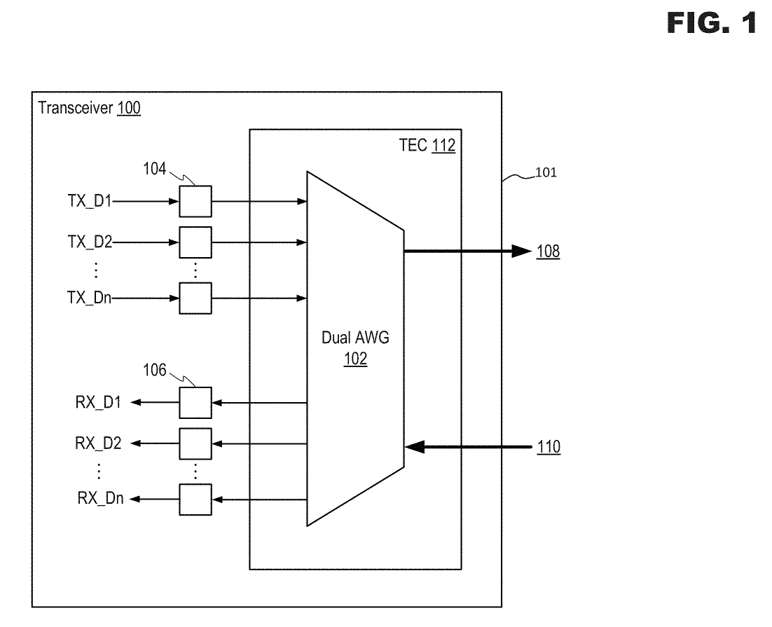

FIG. 1 illustrates an example configuration for an optical transceiver including a thermal dual AWG consistent with the present disclosure. Initially, while FIG. 1 depicts an example configuration for transceiver 100 that may comprise specific components arranged, coupled, oriented, etc. in a particular manner, the example configuration illustrated FIG. 1 has been presented herein merely for the sake of explanation. Rearrangement, insertion, removal, replacement, etc. of the various components disclosed in regard to transceiver 100 is both permissible and foreseeable consistent with the various teachings of the present disclosure. Moreover, the inclusion of an apostrophe after an item number in a drawing figure (e.g., 100′) may indicate that an example embodiment of the particular item is being shown. These example embodiments are not intended to limit the present disclosure to only what is illustrated, and have been presented herein merely for the sake of explanation.

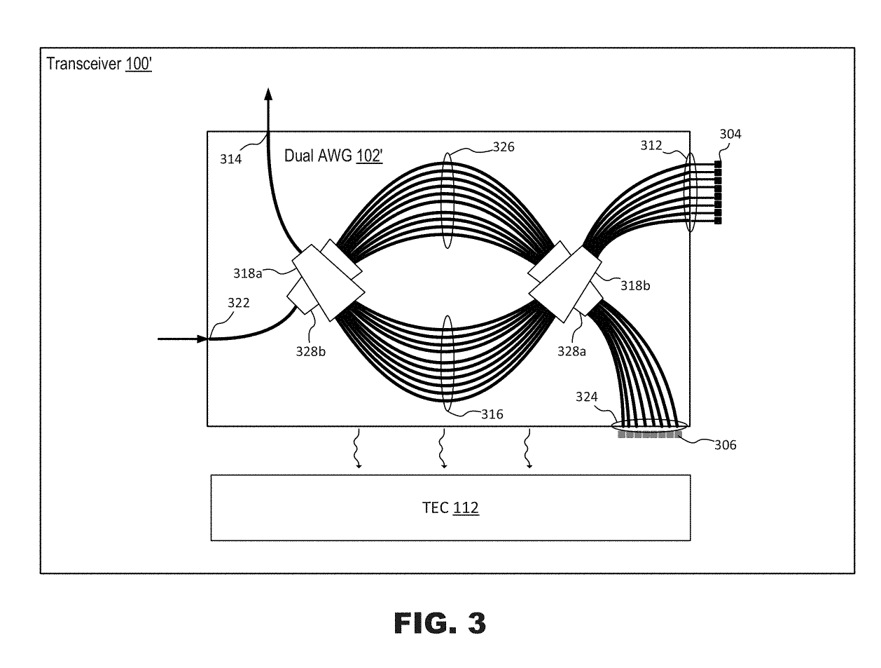

Optical transceiver 100 may be a device within an optical communication network that is able to receive optical signals (e.g., light of various wavelengths transmitted through the optical network) for translation into the electrical domain, and conversely, to receive electrical signals for translation into optical signals for transmission through the optical communication network. Optical transceiver 100 may comprise, for example, a thermal dual AWG 102, a plurality of laser emitters 104, a plurality of photodetectors 106 and a TEC 112 located in a transceiver housing 101. In general, the thermal dual AWG 102 may be used to provide both a TOSA for transmitting multiplexed optical signal 108 and a ROSA for receiving multiplexed optical signal 110. An example configuration for a thermal dual AWG 102 is disclosed further in FIG. 3. As referenced herein, laser emitters 104 may be in the form of a “set” or an “array” at least from a manufacturing perspective (e.g., a plurality of laser emitters 104 may reside in a single package or housing) wherein each laser emitter in the set may be optically coupled to a transmit input in dual AWG 102 in a manner that allows each laser emitter 104 to operate independently in emitting laser light (e.g., generate optical signals) for transmission from transceiver 100.

In an example of operation, at least one laser emitter 104 may be modulated by a respective RF data signal (e.g., TX_D1) to cause the transmission of at least one optical signal into an optical communication system. Similar operations may occur in other laser emitters 104 that may be modulated by other RF data signals (e.g., TX_D2 . . . TX_Dn), and dual AWG 102 may multiplex the optical signals received from the plurality of laser emitters 104 into multiplexed signal 108 prior to transmission in the optical communication system. In a similar manner, a set of photodetectors 106 (e.g., photodiodes) may be optically coupled to respective receive outputs in dual AWG 102, wherein each photodetector 106 may operate individually to generate electrical signals based on light signals received from dual AWG 102. In an example of operation, dual AWG 102 may receive multiplexed optical signal 110 via an optical communication system, and may then demultiplex multiplexed optical signal 110 into a plurality of optical signals (e.g., occurring at different wavelengths) that may be received by the set of photodetectors 106, which may then convert the plurality of optical signals into RF data signals (e.g., RX_D1 . . . RX_Dn).

The performance of the thermal dual AWG 102 may vary based on temperature. To avoid performance variation, TEC 112 may be thermally coupled to at least the dual AWG 102 to control the temperature of the dual AWG 102. An example TEC 112 may comprise at least an electronic component that may use the Peltier effect to generate a heat flux through the association of two different electrically reactive materials. Applying energy to TEC 112 may cause heat to move from one side of the device to the other, causing one side to increase in temperature while the other side cools. By controlling the application of energy to TEC 112, the temperature of devices thermally coupled to TEC 112 (e.g., dual AWG 102) may be controlled based on the requirements of transceiver 100 (e.g., above a minimum temperature, within a temperature range, below a maximum temperature, etc.).

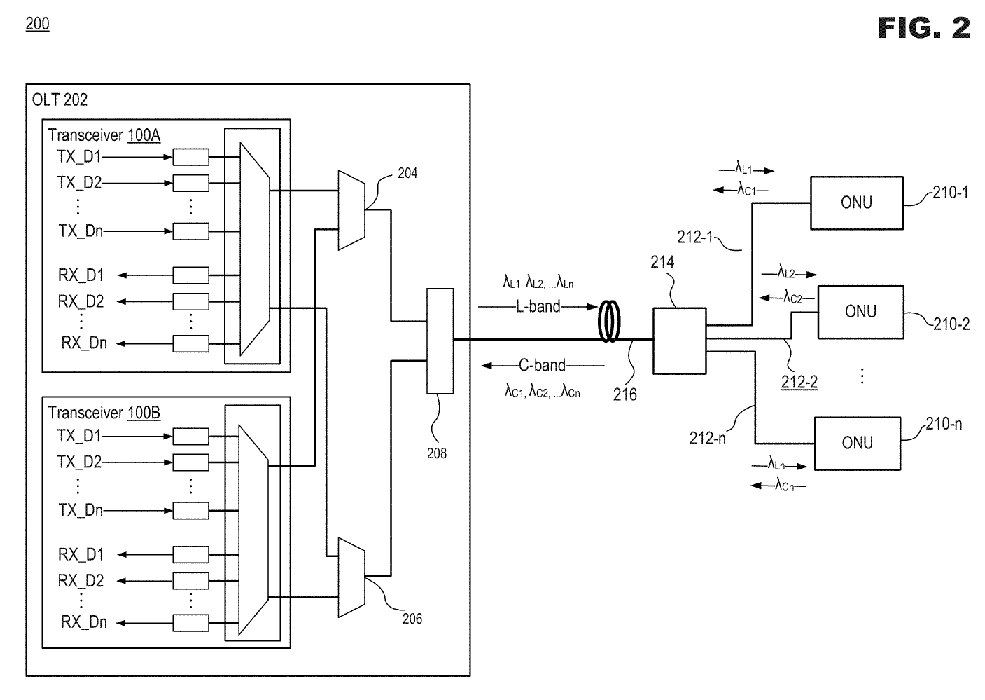

FIG. 2 illustrates a functional diagram of a WDM-PON consistent with the present disclosure. WDM-PON 200 may be a point-to-multipoint optical network architecture using a WDM system. WDM-PON 200 may comprise one or more multi-channel optical transceivers 100 (e.g., 100A and 100B, collectively “100A/B”) in an optical line terminal (OLT) 202 that may be coupled to a plurality of optical networking terminals (ONTs) or optical networking units (ONUs) 210-1 . . . 210-n via optical fibers, waveguides, and/or paths 216 and 212-1 . . . 212-n. Although OLT 202 is shown as including only two multi-channel optical transceivers 100A/B, the number of multi-channel optical transceivers 100 in OLT 202 is not strictly limited to only two.

OLT 202 may be located at a central office of WDM-PON 200, while ONUs 210-1 . . . 210-n may be situated in homes, businesses or other types of subscriber location or premises. Branching point 214 (e.g., a remote node) may couple trunk optical path 216 to separate optical paths 212-1 . . . 212-n, which may be further coupled to ONUs 210-1 . . . 210-n. Branching point 214 may include, for example, one or more passive coupling devices such as a splitter or optical multiplexer/demultiplexer. In one example implementation, ONUs 210-1 . . . 210-n may be located within 20 km of OLT 202.

WDM-PON 200 may also comprise additional nodes or network devices such as, for example, Ethernet PON (EPON) and/or Gigabit PON (GPON) nodes/devices coupled between branching point 214 and ONUs 210-1 . . . 210-n at different locations or premises. At least one application for which WDM-PON 200 may be employed is to provide fiber-to-the-home (FTTH) or fiber-to-the-premises (FTTP) functionality capable of delivering services such as voice, data, video, etc. via a common platform. In this application, the central office may be coupled to one or more sources or networks providing the voice, data and/or video.

Different ONUs 210-1 . . . 210-n may be assigned different channel wavelengths for transmitting and receiving optical signals in WDM-PON 200. In one embodiment, WDM-PON 200 may utilize different wavelength bands for transmission of downstream and upstream optical signals relative to OLT 202 to avoid interference between the received signal and back reflected transmission signal on the same fiber. For example, the L-band (e.g., about 1565 to 1625 nm) may be used for downstream transmissions from OLT 202 and the C-band (e.g., about 1530 to 1565 nm) may be used for upstream transmissions to OLT 202. The particular upstream and/or downstream channel wavelengths may correspond to the International Telecommunication Union (ITU) grid. In one example implementation, the upstream wavelengths may be generally aligned with the 100 GHz ITU grid and the downstream wavelengths may be slightly offset from the 100 GHz ITU grid.

ONUs 210-1 . . . 210-n may thus be assigned different channel wavelengths within the L-band and within the C-band. In at least one example implementation, transceivers or receivers located within ONUs 210-1 . . . 210-n may be configured to receive optical signals on at least one channel wavelength in the L-band (e.g., λ_{L1}, λ_{L2} . . . λ_{Ln}). Transceivers or transmitters located within ONUs 210-1 . . . 210-n may be configured to transmit optical signals on at least one channel wavelength in the C-band (e.g., λ_{C1}, λ_{C2} . . . λ_{Cn}). Other wavelengths and wavelength bands are also within the scope of the system and method described herein.

Branching point 214 may demultiplex a downstream WDM optical signal (e.g., λ_{L1}, λ_{L2} . . . λ_{Ln}) from OLT 202 for transmission of the separate channel wavelengths to the respective ONUs 210-1 . . . 210-n. Alternatively, branching point 214 may provide the downstream WDM optical signal to each of ONUs 210-1 . . . 210-n and each of ONUs 210-1 . . . 210-n may separate and process the assigned optical channel wavelength. The individual optical signals may be encrypted to prevent eavesdropping on optical channels not assigned to a particular ONU 210. Branching point 214 may also combine or multiplex the upstream optical signals from respective ONUs 210-1 to 210-n for transmission as an upstream WDM optical signal (e.g., λ_{C1}, λ_{C2} . . . λ_{Cn}) over the trunk optical path 216 to OLT 202.

OLT 202 may be configured to generate multiple optical signals at different channel wavelengths (e.g., λ_{L1}, λ_{L2} . . . λ_{Ln}) and to combine the optical signals into the downstream WDM optical signal carried on the trunk optical fiber or path 216. Each multi-channel transceiver 100A/B in OLT 202 may include at least one multi-channel TOSA for generating and combining the optical signals at the multiple channel wavelengths. OLT 202 may also be configured to separate optical signals at different channel wavelengths (e.g., λ_{C1}, λ_{C2} . . . λ_{Cn}) from an upstream WDM optical signal carried on the trunk path 216 and to receive the separated optical signals. Each of transceivers 100A/B may thus include at least one multi-channel ROSA for separating and receiving the optical signals at multiple channel wavelengths. The TOSA and ROSA are integrated using a thermal dual AWG, as described in greater detail below.

The multi-channel TOSA is formed by the array of laser emitters 104 coupled to the transmit inputs of the thermal dual AWG 102. The laser emitters 104 (e.g., as disclosed in FIG. 1) may be modulated by respective RF data signals (e.g., TX_D1 . . . TX_Dn) to generate respective optical signals. Laser emitters 104 may be modulated using various modulation techniques including external modulation and direct modulation. The dual AWG 102 may then combine the optical signals at the different respective downstream channel wavelengths (e.g., λ_{L1}, λ_{L2} . . . λ_{Lm}).

In at least one embodiment, laser emitters 104 may be tunable to generate the optical signals at the respective channel wavelengths. In other embodiments, laser emitters 104 generate optical signals over a band of channel wavelengths to which filtering and/or multiplexing techniques may be applied to produce the assigned channel wavelengths. Examples of optical transmitters including a laser array and AWG are disclosed in greater detail in U.S. patent application Ser. No. 13/543,310 (U.S. Patent Application Pub. No. 2013-0016971), U.S. patent application Ser. No. 13/357,130 (U.S. Patent Application Pub. No. 2013-0016977), and U.S. patent application Ser. No. 13/595,505 (U.S. Patent Application Pub. No. 2013-0223844), all of which are fully incorporated herein by reference. In the illustrated embodiment, OLT 202 may further comprise multiplexer 204 for multiplexing the multiplexed optical signals received from multi-channel TOSAs in transceivers 100A/B to produce the downstream aggregate WDM optical signal.

The multi-channel ROSA is formed by the array of photodiodes 106 coupled to receive outputs of the thermal dual AWG 102. The dual AWG 102 separates respective upstream channel wavelengths (e.g., λ_{C1}, λ_{C2} . . . λ_{Cn}) from a received multiplex optical signal 110. The photodetectors 106 detect the optical signals at the respective separated upstream channel wavelengths and generate RF data signals (e.g., RX_D1 . . . RX_Dn) based on the received optical signals. In the illustrated embodiment, OLT 202 may further comprise demultiplexer 206 for demultiplexing the upstream WDM optical signal into first and second WDM optical signals for distribution to transceivers 100A/B. OLT 202 may also comprise diplexer 208 between trunk path 216 and multiplexers 204 and 206 such that trunk path 216 may convey both the upstream and the downstream channel wavelengths. Transceivers 100A/B may include other components such as, for example, laser drivers, transimpedance amplifiers (TIAs), and control interfaces, used for transmitting and receiving optical signals.

In at least one example implementation, each of transceivers 100A/B may be configured to transmit and receive sixteen (16) optical channels such that WDM-PON 200 may support thirty-two (32) downstream L-band channel wavelengths and 32 upstream C-band channel wavelengths. As mentioned above, the upstream and downstream channel wavelengths may span a range of channel wavelengths on the 100 GHz ITU grid. Each of the transceivers 100A/B may, for example, cover sixteen (16) channel wavelengths in the L-band for a TOSA and 16 channel wavelengths in the C-band for a ROSA such that transceivers 100A/B may together cover 32 channels. Multiplexer 204 may combine the sixteen (16) channels from transceiver 102A with sixteen (16) channels from transceiver 102n, and demultiplexer 206 may separate a thirty-two (32) channel WDM optical signal into two sixteen (16) channel WDM optical signals. According to at least one embodiment, a desired wavelength precision or accuracy of transceivers 100A/B may be ±0.05 nm, a desired operating temperature may be between −5 and 70° C., and a desired power dissipation may be approximately 16.0 W.

FIG. 3 illustrates an optical transceiver 100′ including an example implementation of a thermal dual AWG 102′ consistent with the present disclosure. The thermal dual AWG 102′ includes a transmit portion formed by a plurality of transmit inputs 312, a transmit output 314 and transmit waveguides 316 between the transmit inputs 312 and the transmit output 314. The thermal dual AWG 102′ also includes a receive portion formed by a receive input 322, a plurality of receive outputs 324, and receive waveguides 326 between the receive input 322 and the receive outputs 324. This embodiment of the thermal AWG 102′ also includes transmit free propagation areas or regions 318a, 318b coupled at each end of the transmit waveguides 316 and receive free propagation areas or regions 328a, 328b coupled at each end of the receive waveguides 326, which combine or separate different wavelengths of light, for example, using AWG techniques known to those skilled in the art.

The thermal dual AWG 102′ is thermally coupled to a TEC 112 such that the temperature of transmit portion and the receive portion of the dual AWG 102′ may be maintained by the TEC 112. Although the dual AWG 102′ is shown schematically as thermally coupled to the TEC 112, the dual AWG 102′ may be formed as an AWG chip that is mounted on a temperature control surface of the TEC 112. In this embodiment, the transmit and receive portions of the dual AWG 102′ are generally positioned in an overlapping arrangement to ensure that substantially all of the combined surface area of the transmit and receive portions may be thermally coupled with a temperature control surface of TEC 112 in a manner that allows TEC 112 to affect temperature control over the dual AWG 102′.

The transmit inputs 312 are optically coupled to laser emitters 104 and the transmit output 314 may be optically coupled to a transmit optical fiber (not shown) to provide TOSA functionality using the dual AWG 102′. The laser emitters 104 may be directly optically coupled to the transmit inputs 312 or may be optically coupled using lenses, fiber segments, or other waveguides. The laser emitters 104 may be coupled to the AWG 102′, for example, using the techniques disclosed in U.S. Patent Application Publication No. 2013/0188951, which is commonly owned and fully incorporated herein by reference. The receive input 322 may be optically coupled to an input optical fiber and the receive outputs 324 are optically coupled to photodetectors 306 to provide ROSA functionality using the dual AWG 102′. The photodetectors 306 may be directly optically coupled to the receive outputs 324 or may be coupled using lenses, fiber segments, or other waveguides. The photodetectors 306 may be coupled to the AWG 102′, for example, using the techniques disclosed in U.S. Patent Application Publication No. 2014/0341578, which is commonly owned and fully incorporated herein by reference.

In an example transmit operation, transmit inputs 312 may receive optical signals from the respective laser emitters 104. The optical signals may be emitted from the laser emitters 104 as different channel wavelengths and/or may be filtered to different channel wavelengths as a result of passing through the transmit waveguides 316 in the dual AWG 102′. The optical signals may be multiplexed into a multiplexed optical signal emitted from the transmit output 314. In an example receive operation, a multiplexed optical signal may be received via receive input 322 and demultiplexed into different channel wavelengths that pass through the receive waveguides 326, respectively, to the receive outputs 324. A plurality of optical signals corresponding to the different channel wavelengths may then be output via receive outputs 324 and detected by photodetectors 306.

By integrating both transmit and receive functionality into a single dual AWG, the transceiver 100′ may reduce the space required because a separate TOSA and ROSA is not required. Moreover, by overlapping the transmit portion and the receiver portion in the dual AWG 102′, a single TEC may be used to maintain the temperature for purposes of stabilizing the wavelengths when both multiplexing/transmitting and demultiplexing/receiving. Using a single TEC with a single thermal AWG reduces the cost of the transceiver and avoids the power demands of multiple TECs.

The TEC 112 may also be thermally coupled to the laser emitters 104 for controlling the temperature of the laser emitters 104. The temperature of the AWG and/or laser emitters may be controlled, for example, using the techniques disclosed in U.S. Pat. No. 8,831,433, which is commonly owned and fully incorporated herein by reference.

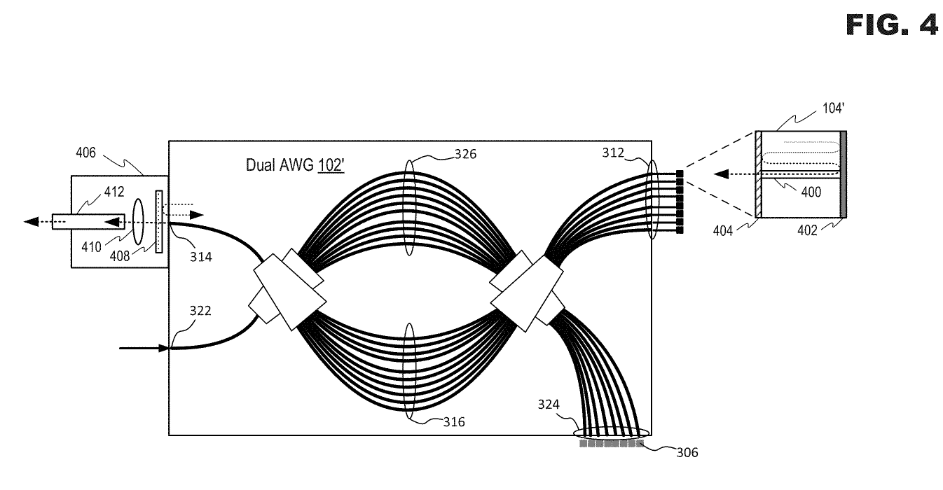

Referring to FIG. 4, a thermal dual AWG 102′ may be used in a laser array mux assembly with an external reflector, such as the type disclosed in U.S. Patent Application Publication No. 2013/0016977, which is commonly owned and fully incorporated herein by reference. In this embodiment, each of the laser emitters emits light across a plurality of wavelengths including the channel wavelengths and the transmit portion of the dual AWG 102′ filters the emitted light from each of laser emitters at different channel wavelengths associated with each of the laser emitters. The external partial reflector reflects at least a portion of the filtered light back into the dual AWG 102′ such that lasing occurs at the channel wavelengths of the reflected, filtered light.

In this embodiment, each laser emitter 104′ includes a gain region 400 that may generate light across the range of wavelengths and amplifies light to provide the gain that results in lasing when the gain exceeds the cavity losses. This embodiment of laser emitter 104′ also includes a back reflector 402 on a back side and an anti-reflective coating 404 on an opposite side coupled to the respective transmit input 302. Back reflector 402 reflects light (e.g., at the channel wavelength) from the laser emitter 104′ and anti-reflective coating 404 allows light to pass into and out of the gain region 400 of the laser emitter 104′.

Each laser emitter 104′ may include multiple quantum-well active regions or other gain media capable of emitting a spectrum of light across a range of wavelengths and capable of amplifying light reflected back into the gain media. Laser emitter 104′ may be, for example, a laser or gain chip such as a semiconductor or diode laser (e.g., Fabry-Perot (FP) diode laser). Back reflector 402 may be highly reflective (e.g., at least 80% reflective) and may include a cleaved facet on a laser or gain chip, a reflective coating on the chip, or a distributed Bragg reflector (DBR) on the gain chip or separate from the gain chip. The anti-reflective coating 404 may have a reflectivity as small as possible (e.g., less than 1% reflective).

In this embodiment, a partial reflector 408 is optically coupled to transmit output 314 of the dual AWG 102′ and an optical fiber 412 is optically coupled to the partial reflector 408 using, for example, lens 410. Partial reflector 408 has partial reflectivity across the channel wavelengths (λ₁ to λₙ), which is sufficient to achieve lasing at those wavelengths. When the external assembly is used in OLT 202 of WDM-PON 200 (e.g., as shown in FIG. 2), for example, partial reflector 408 may provide about 50% reflectivity across wavelengths in the L band. Partial reflector 408 may comprise, for example, a partially reflective coating, a thin film reflector, or a fiber grating (e.g., a 50% fiber Bragg grating). When partial reflector 408 is a fiber grating, a single port V-groove block 406 may be employed to align the fiber grating with transmit output 314 and the optical fiber 412.

Partial reflector 408 may thus act as an exit mirror that completes the lasing cavity. Because the lasing cavity is completed after the dual AWG 102′, the reflected light is filtered by the dual AWG 102′ and only the reflected light at the filtered channel wavelengths is reflected back to the gain regions in the respective laser emitters 104′. Thus, lasing may occur only at one or more of the channel wavelengths.

Accordingly, a thermal dual AWG, consistent with the present disclosure, allows a single AWG chip to be used for both transmit and receive functions in an optical transceiver, thereby saving costs as compared to using an athermal AWG or using multiple AWGs. The dual AWG has overlapping transmit and receive portions to facilitate temperature control with a single TEC, which also reduces costs and power demand.

According to one aspect, an optical transceiver device includes a thermal dual arrayed waveguide grating (AWG) including a transmit portion and a receive portion. The transmit portion includes at least one set of transmit inputs, at least one transmit output and at least one set of transmit waveguides between the transmit inputs and the transmit output to multiplex optical signals into a multiplexed optical signal for transmission. The receive portion includes at least one receive input, at least one set of receive outputs and at least one set of receive waveguides between the receive input and the receive outputs to demultiplex a received multiplexed optical signal. The optical transceiver also includes a plurality of laser emitters optically coupled to the transmit inputs, respectively, and a plurality of photodetectors optically coupled to the receive outputs, respectively. The optical transceiver further includes a thermoelectric cooler (TEC) thermally coupled to at least the thermal dual AWG and configured to control a temperature of at least the thermal dual AWG.

According to another aspect, a wavelength division multiplexed passive optical network includes at least one optical transceiver as described above.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An optical transceiver device, comprising:
a thermal dual arrayed waveguide grating (AWG) including a transmit portion including at least one set of transmit inputs, at least one transmit output and at least one set of transmit waveguides between the transmit inputs and the transmit output to multiplex optical signals into a multiplexed optical signal for transmission, the thermal dual AWG further including a receive portion including at least one receive input, at least one set of receive outputs and at least one set of receive waveguides between the receive input and the receive outputs to demultiplex a received multiplexed optical signal;
a plurality of laser emitters optically coupled to the transmit inputs, respectively;
a plurality of photodetectors optically coupled to the receive outputs, respectively; and
a thermoelectric cooler (TEC) thermally coupled to at least the thermal dual AWG and configured to control a temperature of at least the thermal dual AWG.

2. The optical transceiver device of claim 1, wherein the transmit portion and the receive portion of the thermal dual AWG are arranged to at least partially overlap each other to facilitate the thermal coupling to the TEC.

3. The optical transceiver device of claim 2, wherein the partially overlapping arrangement facilitates substantially all of a combined surface area of the transmit portion and the receive portion of the thermal dual AWG being thermally coupled to a temperature control surface of the TEC.

4. The optical transceiver device of claim 1 wherein the thermal dual AWG is formed in a single chip.

5. The optical transceiver device of claim 1, further comprising a housing to house the thermal dual AWG, the plurality of laser emitters, the plurality of photodetectors and the TEC.

6. The optical transceiver device of claim 1, wherein the TEC is also thermally coupled to the plurality of laser emitters and the TEC is configured to control a temperature of the plurality of laser emitters.

7. The optical transceiver device of claim 1, further comprising an external reflector coupled to the transmit output to form external laser cavities in the at least one set of transmit waveguides.

8. The optical transceiver device of claim 7, wherein each of the plurality of laser emitters include a back reflector on one side and an anti-reflective coating on an opposite side optically coupled to a respective transmit input.

9. The optical transceiver device of claim 7, wherein the plurality of laser emitters are gain chips.

10. The optical transceiver device of claim 1, wherein the plurality of laser emitters are Fabry-Perot (FP) laser emitters.

11. An optical line terminal comprising:
at least first and second multi-channel transceivers, each of the multi-channel transceivers comprising:
a transceiver housing;
a thermal dual arrayed waveguide grating (AWG) located in the transceiver housing and including a transmit portion including at least one set of transmit inputs, at least one transmit output and at least one set of transmit waveguides between the transmit inputs and the transmit output to multiplex optical signals into a multiplexed optical signal for transmission, the thermal dual AWG further including a receive portion including at least one receive input, at least one set of receive outputs and at least one set of receive waveguides between the receive input and the receive outputs to demultiplex a received multiplexed optical signal;
a plurality of laser emitters located in the transceiver housing and optically coupled to the transmit inputs, respectively;
a plurality of photodetectors located in the transceiver housing and optically coupled to the receive outputs, respectively; and
a thermoelectric cooler (TEC) located in the transceiver housing and thermally coupled to at least the thermal dual AWG and configured to control a temperature of at least the thermal dual AWG.

12. The network of claim 11, wherein the transmit portion and the receive portion of the thermal dual AWG are arranged to at least partially overlap each other to facilitate the thermal coupling to the TEC.

13. The network of claim 12, wherein the partially overlapping arrangement facilitates substantially all of a combined surface area of the transmit portion and the receive portion of the thermal dual AWG being thermally coupled to a temperature control surface of the TEC.

14. The network of claim 11, wherein the thermal dual AWG is formed in a single chip.

15. The network of claim 11, further comprising a housing to house the thermal dual AWG, the plurality of laser emitters, the plurality of photodetectors and the TEC.

16. The network of claim 11, wherein the TEC is also thermally coupled to the plurality of laser emitters and the TEC is configured to control a temperature of the plurality of laser emitters.

17. The network of claim 11, further comprising an external reflector coupled to the transmit output to form external laser cavities in the at least one set of transmit waveguides.

18. The network of claim 17, wherein the plurality of laser emitters are gain chips.

19. The network of claim 17, wherein the plurality of laser emitters are Fabry-Perot (FP) laser emitters.
